(19) United States
(12) Patent Application Publication
(10) Pub. No.: US 2009/0242607 A1
(43) Pub. Date: Oct. 1, 2009

(54) NAIL MAGAZINE WITH A WIDTH-ADJUSTABLE NAIL-RECEIVING SPACE

(75) Inventor: Angi Liu, Taichung (TW)

Correspondence Address: DARBY & DARBY P.C., P.O. BOX 770, Church Street Station, New York, NY, 10008-0770, US

(73) Assignee: BASSO INDUSTRY CORP., Taichung (TW)

(21) Appl. No.: 12/055,073

(22) Filed: Mar. 25, 2008

(51) Int. Cl. B27F 7/00

(52) U.S. Cl. 227/120

(57) ABSTRACT

A nail magazine includes a magazine seat having a nail slot, and a nail-engaging member disposed movably within the nail slot to define a nail-receiving space between a slot-defining wall unit of the magazine seat and the nail-engaging member. The nail-engaging member is formed with first and second contact portions. A driving seat is movable on the magazine seat between first and second positions along a longitudinal direction of the nail slot. When the driving seat is disposed at the first position, a pushing unit attached to the driving seat is in contact with the first contact portion. When the driving seat is moved to the second position, the nail-engaging member is moved away from the slot-defining wall unit along a transverse direction perpendicular to the longitudinal direction such that the pushing unit comes into contact with the second contact portion to thereby increase the width of the nail-receiving space.

### BACKGROUND OF THE INVENTION

1. Field of the Invention

This invention relates to a nail gun, and more particularly to a nail magazine for a nail gun, which has a width-adjustable nail-receiving space.

2. Description of the Related Art

Referring to FIG. 1, a conventional nail magazine disclosed in Taiwanese Utility Model Publication No. M249777 by the applicant forms a portion of a nail gun (not shown), and includes a magazine seat 11, a nail-engaging plate 12 made of metal, a bolt 13, and a resilient member 14. The magazine seat 11 has a nail slot 111, a positioning hole formed in a side surface of the magazine seat 111 and having a first retaining portion 112, a second retaining portion 113, and a neck portion 114 connected between the first and second retaining portions 112, 113, and two rod-engaging holes 115. The nail-engaging plate 12 is disposed within the nail slot 111, and has a nail-engaging side surface 121, and a seat-engaging side surface 121′ opposite to the nail-engaging side surface 121 and formed with two projecting rods 122 and two projecting blocks 123. The bolt 13 extends through a mounting wall 116 of the magazine seat 11 formed with the positioning hole, and is connected fixedly to the nail-engaging plate 12. The bolt 13 has a head 131 disposed at an end thereof, and an annular outward flange 132 disposed in proximity to an opposite end thereof and engageable fittingly within a selected one of the first and second retaining portions 112, 113 of the positioning hole. The resilient member 14 is disposed between the head 131 and the magazine seat 11 for biasing the nail-engaging plate 12 to move away from a slot-defining wall 117 of the magazine seat 11 defining a side of the nail slot 111 and for biasing the outward flange 132 to engage the selected one of the first and second retaining portions 112, 113 of the positioning hole.

To adjust the width of a nail-receiving space defined between the nail-engaging side surface 121 of the nail-engaging plate 12 and the slot-defining wall 117, the head 131 of the bolt 13 is pressed to remove the outward flange 132 from the selected one of the first and second retaining portions 112, 113 of the positioning hole. Next, the bolt 13 and therefore the nail-engaging plate 12 are moved relative to the magazine seat 11 along a longitudinal direction (A) of the nail slot 111. When the nail-engaging plate 12 is disposed at a first position shown in FIG. 1, the projecting rods 122 are in contact with the mounting wall 116 of the magazine seat 11. In the first position, the nail-receiving space is narrow, and a row of small-size nails 2 can be loaded thereinto such that movement of the row of the small-size nails 2 within the nail slot 111 in a transverse direction (B) perpendicular to the longitudinal direction (A) is prevented. The nail-engaging plate 12 can be moved from the first position to a second position whereat the projecting rods 122 are inserted respectively into the rod-engaging holes 115 and whereat the projecting blocks 123 are in contact with the mounting wall 116 of the magazine seat 11. In the second position, the nail-receiving space becomes wider, and a row of large-size nails (not shown) can be loaded thereinto such that movement of the row of the large-size nails within the nail slot 111 in the transverse direction (B) is prevented.

However, during the width adjustment operation of the nail magazine, the metal nail-engaging plate 12 moves within the nail slot 111 in both the longitudinal direction (A) and the transverse direction (B), thereby resulting in difficulties in moving the bolt 13.

### SUMMARY OF THE INVENTION

The object of this invention is to provide a nail magazine that includes a nail-engaging member, which can be easily moved to adjust the width of a nail-receiving space.

Accordingly, the nail magazine of this invention includes a magazine seat having a nail slot, and a nail-engaging member disposed movably within the nail slot to define a nail-receiving space between a slot-defining wall unit of the magazine seat and the nail-engaging member. The nail-engaging member has first and second contact portions. A driving seat is movable on the magazine seat between first and second positions along a longitudinal direction of the nail slot. When the driving seat is disposed at the first position, a pushing unit attached on the driving seat is in contact with the first contact portion. When the driving seat is moved to the second position, the nail-engaging member is moved away from the slot-defining wall unit along a transverse direction perpendicular to the longitudinal direction so that the pushing unit comes into contact with the second contact portion to thereby increase the width of the nail-receiving space.

Since the nail-engaging member is movable along only a direction toward and away from the slot-defining wall unit of the magazine seat, it can be easily operated.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a conventional nail magazine disclosed in Taiwanese Utility Model Publication No. M249777;

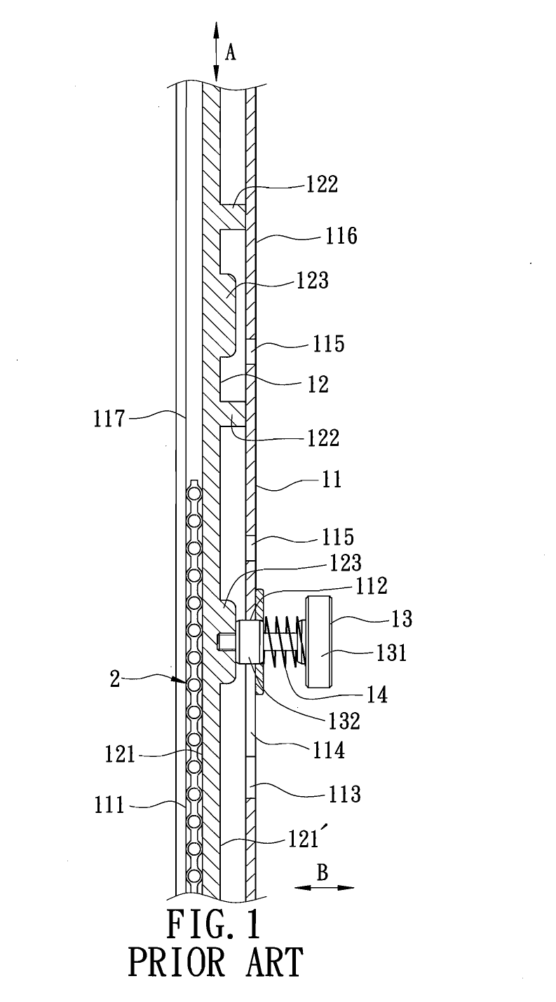

FIG. 2 is an assembled perspective view of the preferred embodiment of a nail magazine according to this invention;

FIG. 3 is an exploded perspective view of the preferred embodiment;

FIG. 4 is a top view of the preferred embodiment when a driving seat is disposed at a first position;

FIG. 5 is a sectional view taken along Line V-V in FIG. 4;

FIG. 6 is a partly sectional view of the preferred embodiment when the driving seat is disposed at the first position, illustrating how a row of small-size nails is received within a nail slot;

FIG. 7 is a top view of the preferred embodiment when the driving seat is disposed at a second position;

FIG. 8 is a sectional view taken along Line VIII-VIII in FIG. 7; and

FIG. 9 is a partly sectional view of the preferred embodiment when the driving seat is disposed at the second position, illustrating how a row of large-size nails is received within the nail slot.

### DETAILED DESCRIPTION OF THE PREFERRED EMBODIMENT

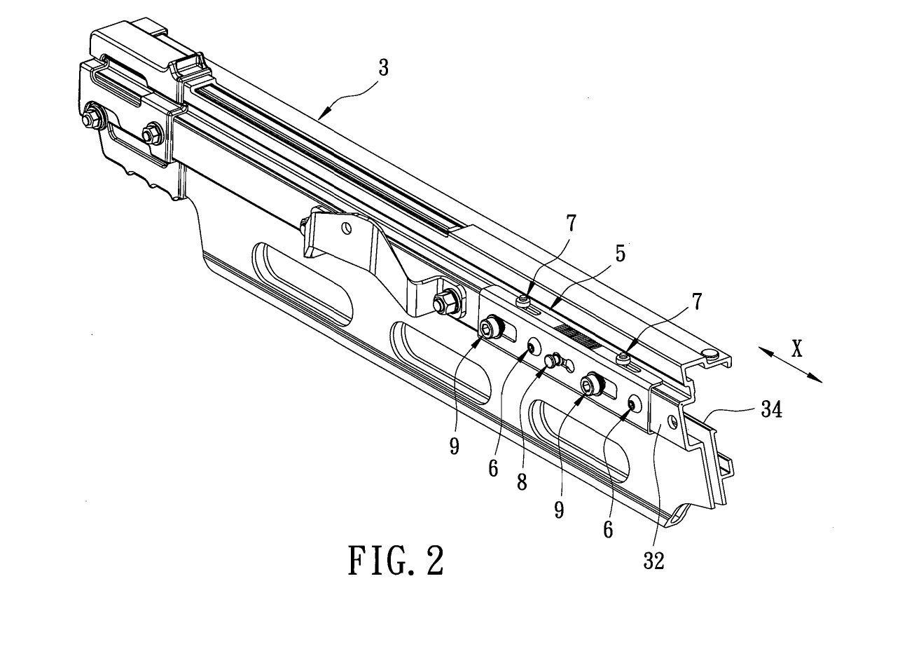

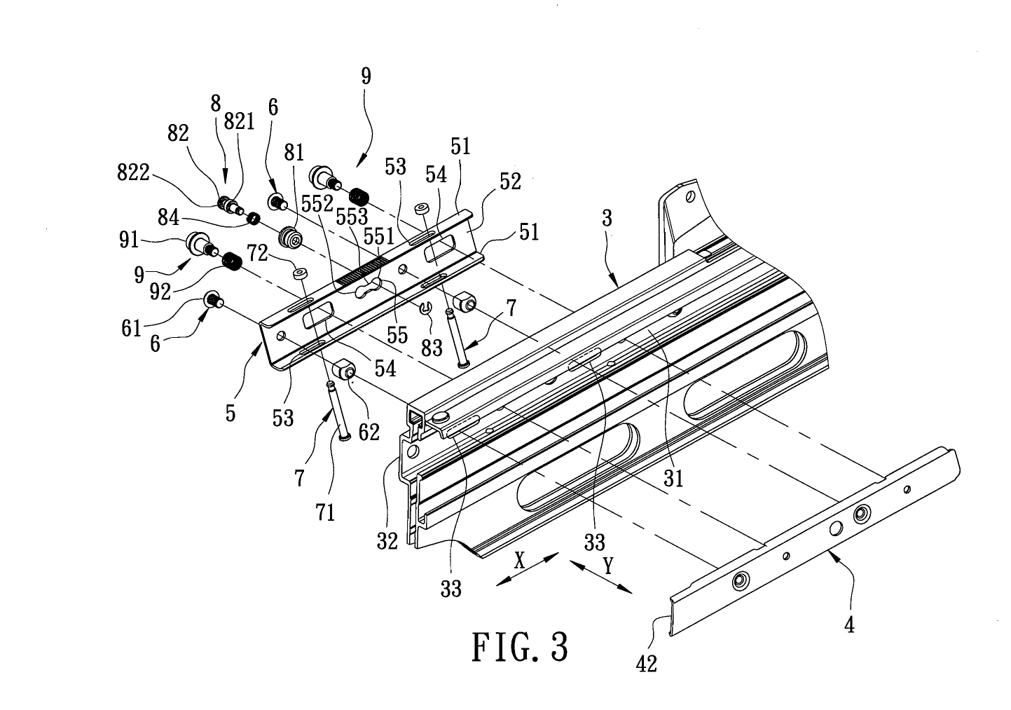

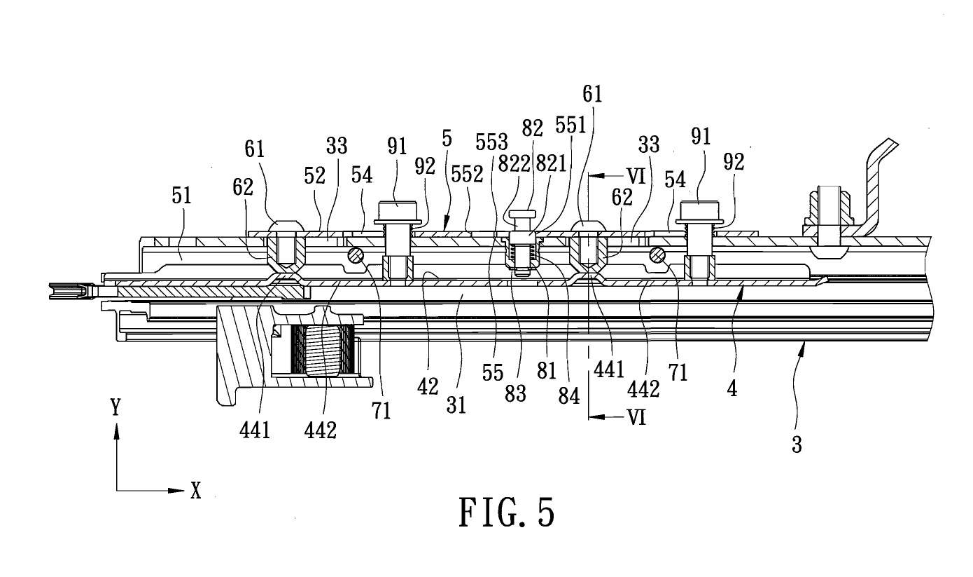

Referring to FIGS. 2 to 6, the preferred embodiment of a nail magazine according to this invention forms a portion of a nail gun (not shown), and includes a magazine seat 3, a nail-engaging member 4, and a driving unit.

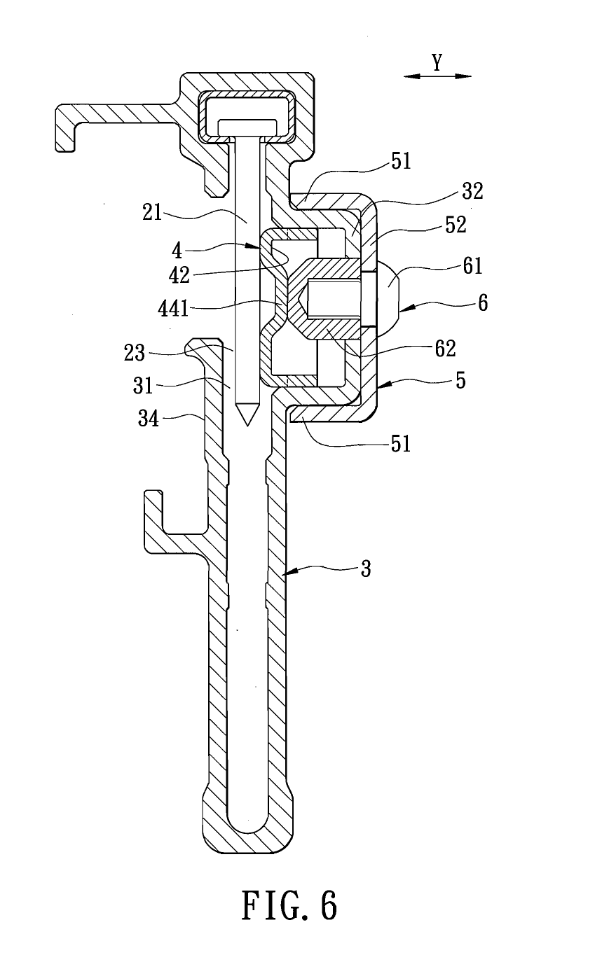

The magazine seat 3 has a nail slot 31 formed in a side thereof and extending along a longitudinal direction (X) for receiving a row of nails 21 (only one is shown in FIG. 6), an elongated mounting portion 32 projecting from an opposite side of the magazine seat 3 and extending along the longitudinal direction (X), and two elongated openings 33 formed through the mounting portion 32 along a transverse direction (Y) perpendicular to the longitudinal direction (X) and extending and aligned with each other along the longitudinal direction (X).

The nail-engaging member 4 is disposed within the nail slot 31 to allow the row of the nails 21 to be received between the nail-engaging member 4 and a slot-defining wall unit 34 of the magazine seat 3 defining a side of the nail slot 31. In other words, a nail-receiving space 23 is defined between the nail-engaging member 4 and the slot-defining wall unit 34 along the transverse direction (Y). The nail-engaging member 4 has a side surface 42 facing the row of the nails 21 and formed with two first contact portions 441 and two second contact portions 442. In this embodiment, the first contact portions 441 are configured as raised surface portions, and the second contact portions 442 are configured as sides of ribs distal from the side surface 42 of the nail-engaging member 4. The second contact portions 442 are nearer to the side surface 42 than the first contact portions 441.

The driving unit includes a driving seat 5, two pushing units 6, two position-limiting units 7, a positioning unit 8, and two connecting units 9.

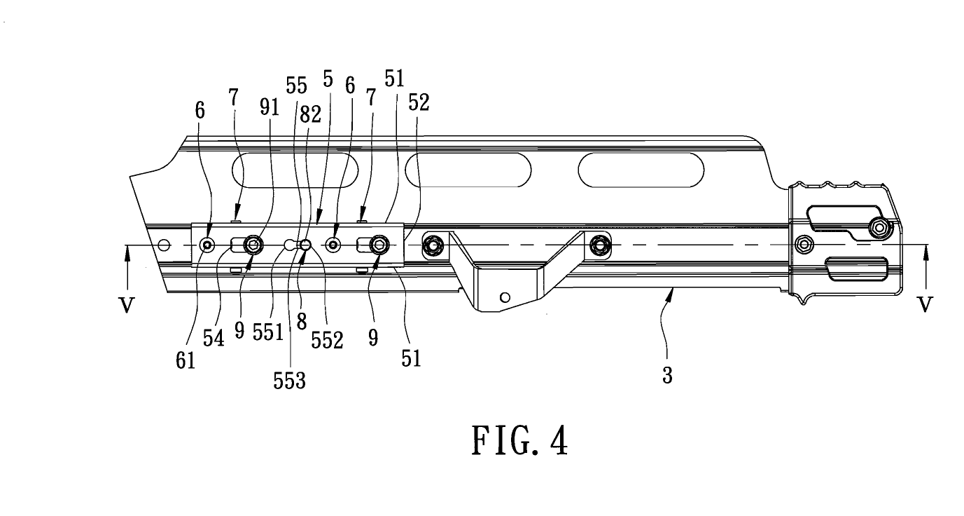

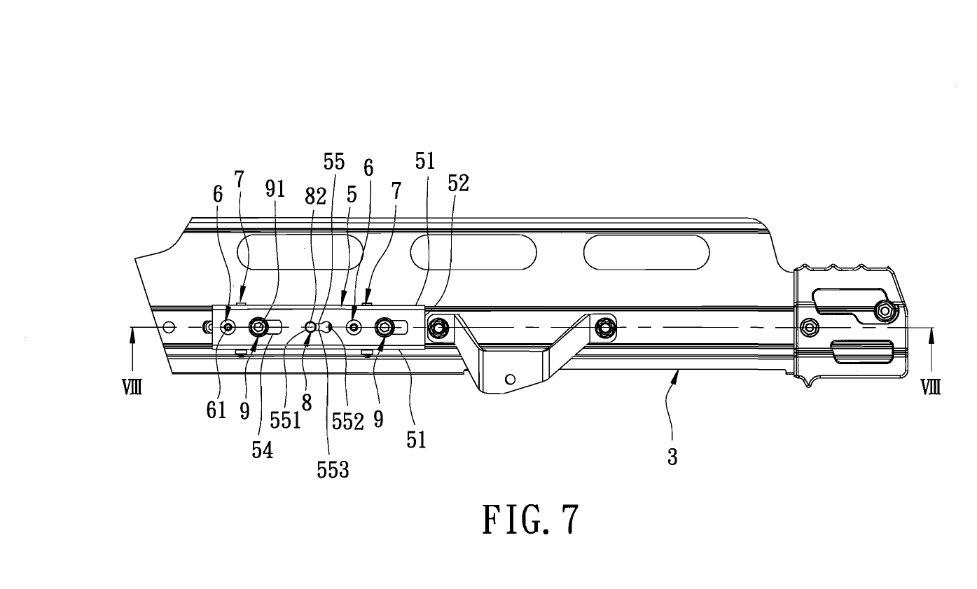

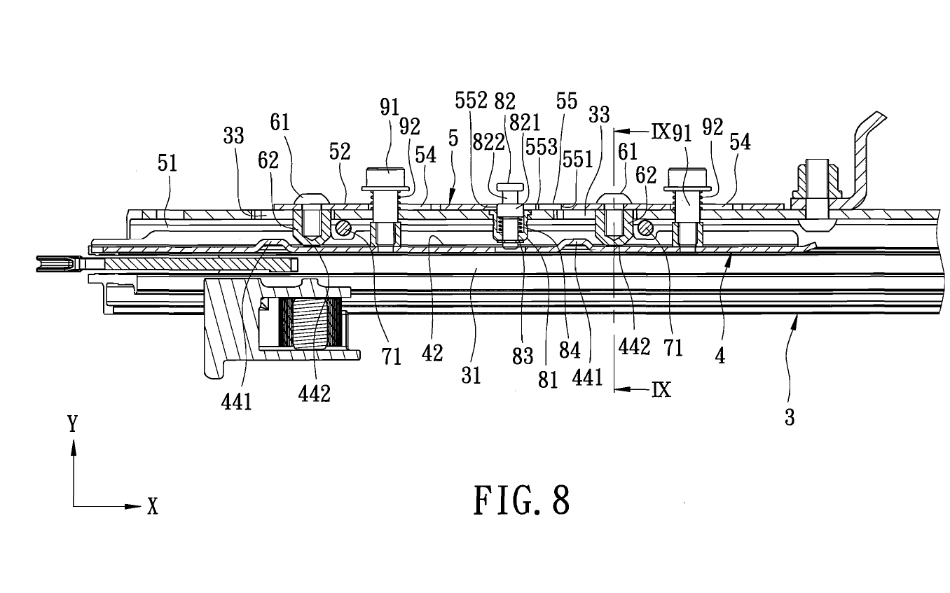

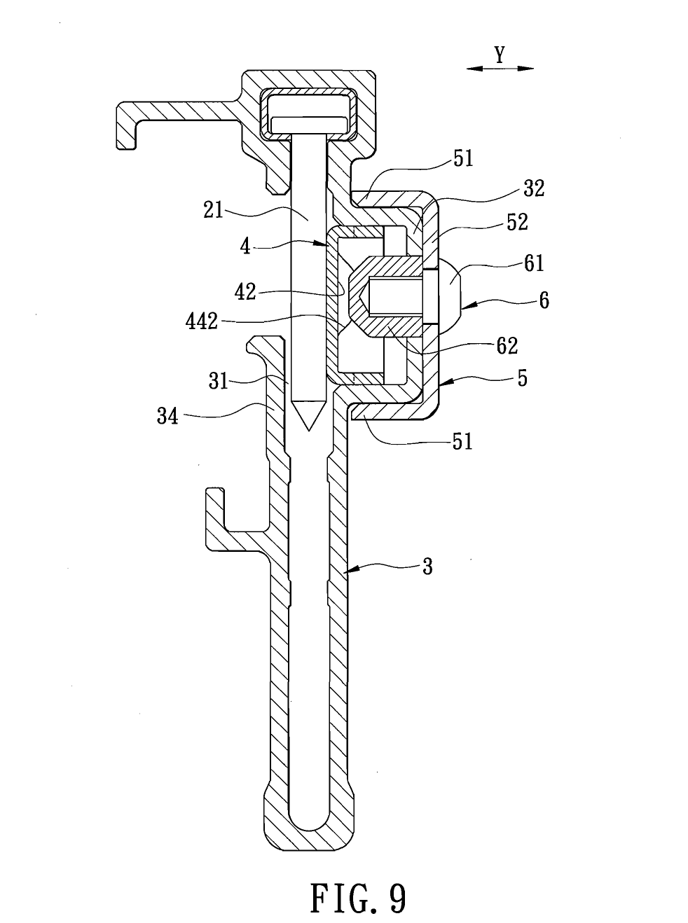

The driving seat 5 is movable on the mounting portion 32 of the magazine seat 3 between a first position shown in FIGS. 4, 5, and 6 and a second position shown in FIGS. 7, 8, and 9. In this embodiment, the driving seat 5 is U-shaped, and includes two parallel side plates 51 in slidable contact with two opposite sides of the mounting portion 32 of the magazine seat 3, respectively, and a connecting plate 52 interconnecting the side plates 51. Each of the side plates 51 has two aligned side slots 53 that are formed therethrough and that extend along the longitudinal direction (X) The connecting plate 52 has two elongated openings 54 that extend along the longitudinal direction (X), and a positioning hole 55 that is formed through the connecting plate 52 along the transverse direction (Y) and that is disposed between the openings 54 along the longitudinal direction (X) The positioning hole 55 has a first retaining portion 551, a second retaining portion 552, and a neck portion 553 connected between the first and second retaining portions 551, 552. The neck portion 553 has a uniform width smaller than the diameter of each of the first and second retaining portions 551, 552.

The pushing units 6 are connected fixedly to the connecting plate 52 of the driving seat 5. In this embodiment, each of the pushing units 6 includes a bolt 61 and an internally threaded pusher 62 engaging an externally threaded end of the bolt 61. The bolts 61 extend respectively through the openings 54 in the driving seat 5. The pushers 62 are in slidable contact with the nail-engaging member 4. The connecting plate 52 of the driving seat 5 is clamped between the bolts 61 and the pushers 62. When the driving seat 5 is disposed at the first position, the pushers 72 are in contact with the first contact portions 441, respectively. When the driving seat 5 is disposed at the second position, the pushers 72 are in contact with the second contact portions 442, respectively. Therefore, when the driving seat 5 is moved from the first position to the second position, the nail-engaging member 4 is moved away from the slot-defining wall unit 34.

Each of the position-limiting units 7 includes a position-limiting member 71 and a retaining ring 72. Each of the position-limiting members 71 extends through the corresponding side slots 53 in the side plates 51 and the mounting portion 32 of the magazine seat 3. Each of the retaining rings 72 is sleeved on an end of the corresponding position-limiting member 71 so as to prevent removal of the corresponding position-limiting member 71 from the driving seat 5 and the magazine seat 3. As such, movement of the driving seat 5 relative to the magazine seat 3 along the longitudinal direction (X) is allowed, and movement of the driving seat 5 relative to the magazine seat 3 along the transverse direction (Y) is prevented.

The positioning unit 8 includes a sleeve 81, a positioning member 82, a C-shaped retaining ring 83, and a resilient member 84. The positioning member 82 extends through the positioning hole 55 in the driving seat 5 and the sleeve 81 along the transverse direction (Y), and has a large-diameter portion 821 and a small-diameter portion 822 having a diameter smaller than that of the large-diameter portion 821. The large-diameter portion 821 is disposed within a selected one of the first and second retaining portions 551, 552 of the positioning hole 55, and is sized so as to prevent movement of the positioning member 82 within the positioning hole 55 along the longitudinal direction (X). The C-shaped retaining ring 83 is sleeved on an end of the positioning member 82 so as to prevent movement of the sleeve 81 relative to the driving seat 5. The resilient member 84 is disposed between the large-diameter portion 821 of the positioning member 82 and the sleeve 81 so as to bias the large-diameter portion 821 of the positioning member 82 into the selected one of the first and second retaining portions 551, 552 of the positioning hole 55 in the driving seat 5. The small-diameter portion 822 can be pressed into the positioning hole 55 against the biasing action of the resilient member 84. Pressing of the small-diameter portion 822 into the positioning hole 55 results in removal of the large-diameter portion 821 from the positioning hole 55 to thereby allow for movement of the positioning member 82 from the selected one of the first and second retaining portions 551, 552 into the other of the first and second retaining portions 551, 552 via the neck portion 533. When the driving seat 5 is disposed at the first position, the large-diameter portion 821 of the positioning member 82 engages fittingly the first retaining portion 551 of the positioning hole 55 to prevent removal of the driving seat 5 from the first position. When the driving seat 5 is disposed at the second position, the large-diameter portion 821 of the positioning member 82 engages fittingly the second retaining portion 552 of the positioning hole 55 to prevent removal of the driving seat 5 from the second position.

Each of the connecting units 9 includes a connecting member 91 and a resilient member 92. Each of the connecting members 91 extends through the corresponding opening 54 in the driving seat 5 and the mounting portion 32 of the magazine seat 3 along the transverse direction (Y), and is connected threadedly to the nail-engaging member 4. The resilient member 92 is disposed between the connecting member 91 and the mounting portion 32 of the magazine seat 3 for biasing the nail-engaging member 4 to move away from the slot-defining wall unit 34 of the magazine seat 3 to contact the pushers 72 of the pushing units 7. As such, the driving seat 5 and the nail-engaging member 4 are movable synchronously relative to the magazine seat 3 along the longitudinal direction (X), and toward and away from each other along the transverse direction (Y).

In a situation where the driving seat 5 is disposed at the second position, when it is desired to load the nail magazine with a row of small-size nails 21, the small-diameter portion 822 of the positioning member 82 is first pressed into the positioning hole 55 to thereby remove the large-diameter portion 821 of the positioning member 82 from the positioning hole 55. Next, the driving seat 5 is moved from the second position to the first position along the longitudinal direction (X) to thereby move the small-diameter portion 822 of the positioning member 82 from the second retaining portion 552 into the first retaining portion 551 via the neck portion 553. Further, the nail-engaging member 4 is moved toward the slot-defining wall unit 34 along the transverse direction (Y) to thereby reduce the width of the nail-receiving space 23 (i.e., the distance between the side surface 42 of the nail-engaging member 4 and the slot-defining wall unit 34) due to contact of pushers 72 with the first contact portions 441, respectively. Subsequently, the small-diameter portion 822 of the positioning member 82 is released. Hence, the large-diameter portion 821 is biased by the resilient member 84 into the first retaining portion 551 of the positioning hole 55 to maintain the driving seat 5 at the first position.

In a situation where the driving seat 5 is disposed at the first position, when it is desired to load the nail magazine with a row of large-size nails 21, the small-diameter portion 822 of the positioning member 82 is first pressed into the positioning hole 55 to thereby remove the large-diameter portion 821 of the positioning member 82 from the positioning hole 55. Next, the driving seat 5 is moved from the first position to the second position along the longitudinal direction (X) to thereby move the small-diameter portion 822 of the positioning member 82 from the first retaining portion 551 into the second retaining portion 552. Hence, the nail-engaging member 4 is biased by the resilient member 92 to move away from the slot-defining wall unit 34 along the transverse direction (Y) to thereby increase the width of the nail-receiving space 23 due to contact of pushers 72 with the second contact portions 442, respectively. Subsequently, the small-diameter portion 822 of the positioning member 82 is released. Hence, the large-diameter portion 821 is biased by the resilient member 84 into the second retaining portion 552 of the positioning hole 55 to maintain the driving seat 5 at the second position.

Since the nail-engaging member 4 is movable in only a direction perpendicular to that of the driving seat 5, the width of the nail-receiving space 23 can be easily adjusted. Thus, the object of this invention can be achieved.

With this invention thus explained, it is apparent that numerous modifications and variations can be made without departing from the scope and spirit of this invention. It is therefore intended that this invention be limited only as indicated by the appended claims.

I claim:

1. A nail magazine comprising:
a magazine seat having a nail slot that extends along a longitudinal direction and that is adapted to receive a row of nails, said nail slot having a side that is defined by a slot-defining wall unit of said magazine seat;
a nail-engaging member disposed movably within said nail slot to define a nail-receiving space between said slot-defining wall unit of said magazine seat and said nail-engaging member, said nail-engaging member cooperating with said slot-defining wall unit to confine the row of the nails therebetween, said nail-engaging member having a side surface that is adapted to face the row of the nails and that is formed with at least one first contact portion and at least one second contact portion; and
a driving unit including a driving seat operable to move on said magazine seat between first and second positions along the longitudinal direction, at least one connecting unit extending through said magazine seat and interconnecting said driving seat and said nail-engaging member to allow for synchronous movement of said driving seat and said nail-engaging member relative to said magazine seat along the longitudinal direction and movement of said nail-engaging member toward and away from said slot-defining wall unit of said magazine seat along a transverse direction perpendicular to the longitudinal direction, and at least one pushing unit attached on said driving seat and extending through said magazine seat;
wherein, when said driving seat is disposed at said first position, said pushing unit is in contact with said first contact portion of said nail-engaging member, and when said driving seat is moved from said first position to said second position, said pushing unit comes into contact with said second contact portion of said nail-engaging member such that said nail-engaging member is moved away from said slot-defining wall unit of said magazine seat along said transverse direction to thereby increase a width of said nail-receiving space.

2. The nail magazine as claimed in claim 1, wherein said magazine seat has an elongated mounting portion projecting from a side thereof and extending along the longitudinal direction, and said driving seat is U-shaped, and includes two parallel sides plates in slidable contact with two opposite sides of said mounting portion of said magazine seat, respectively, and a connecting plate interconnecting said side plates.

3. The nail magazine as claimed in claim 2, wherein said driving unit further includes at least one position-limiting unit interconnecting said driving seat and said magazine seat in such a manner to allow for movement of said driving seat relative to said magazine seat along the longitudinal direction while preventing movement of said driving seat relative to said magazine seat along the transverse direction, said driving seat including at least two side slots formed respectively through said side plates and extending along the longitudinal direction, said position-limiting unit including a position-limiting member extending through said side slots in said side plates and said mounting portion of said magazine seat, and a retaining ring sleeved on an end of said position-limiting member so as to prevent removal of said position-limiting member from said driving seat and said magazine seat.

4. The nail magazine as claimed in claim 2, wherein said driving unit further includes a positioning unit, said driving seat further including a positioning hole, said positioning unit including a positioning member extending through said positioning hole and connected removably to said magazine seat for maintaining said driving seat at a selected one of said first and second positions.

5. The nail magazine as claimed in claim 4, wherein said positioning unit further includes a sleeve, a C-shaped retaining ring, and a resilient member, said positioning hole having a first retaining portion, a second retaining portion, and a neck portion connected between said first and second retaining portions, said positioning member extending through said sleeve and having a large-diameter portion that is disposed within the selected one of said first and second retaining portions of said positioning hole and that is sized so as to prevent movement of said positioning member within said positioning hole along the longitudinal direction, and a small-diameter portion having a diameter smaller than that of said large-diameter portion, said C-shaped retaining ring being sleeved on an end of said positioning member so as to prevent movement of said sleeve relative to said driving seat, said resilient member being disposed between large-diameter portion of said positioning member and said sleeve so as to bias said large-diameter portion of said positioning member into the selected one of said first and second retaining portions of said positioning hole in said driving seat such that said small-diameter portion can be pressed into said positioning hole against the biasing action of said resilient member, pressing of said small-diameter portion into said positioning hole resulting in removal of said large-diameter portion from said positioning hole to thereby allow for movement of said positioning member from the selected one of said first and second retaining portions into the other of said first and second retaining portions via said neck portion.

6. The nail magazine as claimed in claim 2, wherein said driving seat of said driving unit further includes an elongated opening, said connecting unit including a connecting member and a resilient member, said connecting member extending through said opening and said mounting portion of said magazine seat along the transverse direction and being connected fixedly to nail-engaging member, said resilient member being disposed between said connecting member and said magazine seat for biasing said nail-engaging member to move away from said slot-defining wall unit of said magazine seat.

7. The nail magazine as claimed in claim 6, wherein said magazine seat further has an elongated opening formed through said mounting portion along the transverse direction and extending along the longitudinal direction, said pushing unit being connected fixedly to said driving seat and extending through said elongated opening in said magazine seat, said resilient member biasing said pushing unit to contact said nail-engaging member.

8. The nail magazine as claimed in claim 1, wherein said pushing unit includes a bolt extending through said driving seat and having a head and an externally threaded end, and an internally threaded pusher engaging said externally threaded end of said bolt to clamp said driving seat between said head of said bolt and said pusher, said pusher being in slidable contact with said nail-engaging member.
